(19) United States
(12) Patent Application Publication
(10) Pub. No.: US 2026/0280967 A1
(43) Pub. Date: Sep. 17, 2026

(54) LOCATION-BASED NETWORK ANOMALY DIAGNOSTIC

(71) Applicant: Rakuten Mobile, Inc., Tokyo (JP)

(72) Inventors: Anindya SANYAL, Tokyo (JP); Md Nurul AMIN, Tokyo (JP); Rajib CHAKRABARTI, Tokyo (JP)

(73) Assignee: Rakuten Mobile, Inc., Tokyo (JP)

(21) Appl. No.: 19/078,374

(22) Filed: Mar. 13, 2025

(51) Int. Cl. H04L 41/0631; H04L 41/0677; H04L 41/16; H04W 24/08; H04W 64/00

(52) U.S. Cl. CPC H04L 41/0631; H04L 41/0677; H04L 41/16; H04W 24/08; H04W 64/00

(57) ABSTRACT

Example embodiments of the present disclosure relate to location-based network anomaly diagnostic. According to example embodiments, a device may include an Anomaly Detection Component that may be configured to: receive data associated with cell coverage of a plurality of sections of a location and connectivity sessions at the location; determine, based on the received data, a plurality of anomaly detection results, wherein each of the anomaly detection results indicates whether a network anomaly has occurred in a respective one of the plurality of sections; and provide, to a Root Cause Analysis (RCA) Component, data associated with at least one of the anomaly detection results that indicates that a network anomaly has occurred.

### TECHNICAL FIELD

The present disclosure relates to location-based network anomaly diagnostic.

### BACKGROUND

The information disclosed in this background section is only for the enhancement of understanding of the general background of the disclosure and should not be taken as an acknowledgement or any form of suggestion that this information forms the prior art already known to a person skilled in the art.

A telecommunications network consists of various systems and components that interoperate to provide connectivity and services. Various types of anomaly (e.g., a sudden signal quality degradation, an unexpected service disruption, a connectivity failure, etc.) may occur on different systems, components, and operations in the telecommunications network. When an anomaly arises, a timely anomaly diagnostic is crucial for maintaining network operations, minimizing the impact of the anomaly on the network performance, and optimizing user satisfaction. Generally, an anomaly diagnostic includes detecting the occurrence of the anomaly, identifying the root cause of the anomaly, and performing corrective actions to mitigate the anomaly.

### SUMMARY

Example embodiments of the present disclosure provide devices, systems, devices, methods, and the like, that effectively and efficiently provide location-based network anomaly diagnostic.

According to example embodiments, a device may include an Anomaly Detection Component. The Anomaly Detection Component may be configured to receive data associated with cell coverage of a plurality of sections of a location and connectivity sessions at the location, and then determine, based on the received data, a plurality of anomaly detection results. Each of the anomaly detection results indicates whether a network anomaly has occurred in a respective one of the plurality of sections. Accordingly, the Anomaly Detection Component may be configured to provide, to a Root Cause Analysis (RCA) Component, data associated with at least one of the anomaly detection results that indicates that a network anomaly has occurred.

According to example embodiments, a method may include: receiving data associated with cell coverage of a plurality of sections of a location and connectivity sessions at the location; determining, based on the received data, a plurality of anomaly detection results, wherein each of the anomaly detection results indicates whether a network anomaly has occurred in a respective one of the plurality of sections; and providing, to a Root Cause Analysis (RCA) Component, data associated with at least one of the anomaly detection results that indicates that a network anomaly has occurred.

According to example embodiments, a non-transitory computer-readable recording medium may have recorded thereon instructions executable by a device to cause the device to perform a method. The method may include: receiving data associated with cell coverage of a plurality of sections of a location and connectivity sessions at the location; determining, based on the received data, a plurality of anomaly detection results, wherein each of the anomaly detection results indicates whether a network anomaly has occurred in a respective one of the plurality of sections; and providing, to a Root Cause Analysis (RCA) Component, data associated with at least one of the anomaly detection results that indicates that a network anomaly has occurred.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a diagram of an example system configuration, according to one or more example embodiments;

FIG. 2 illustrates a diagram of an example method for processing data to determine network anomaly for a plurality of sections of a location, according to one or more example embodiments;

FIG. 3 illustrates a diagram of an example method for determining a plurality of anomaly detection results, according to one or more example embodiments;

FIG. 4 illustrates a diagram of an example use case in which one or more operations in FIG. 2 and FIG. 3 may be implemented, according to one or more example embodiments;

FIG. 5 illustrates a diagram of an example method for performing causal analysis on data and output a report thereof, according to one or more example embodiments;

FIG. 6 illustrates a diagram of an example use case in which one or more operations in FIG. 5 may be implemented, according to one or more example embodiments;

FIG. 7 illustrates a diagram of an example use case for performing network anomaly diagnostic for a plurality of sections of a railway line, according to one or more example embodiments;

FIG. 8 illustrates a diagram of an example device for implementing one or more example embodiments; and

FIG. 9 illustrates a diagram of an example environment for implementing one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc. In addition, expressions such as “a processor may be configured to perform an operation,” are to be understood as the processor may be configured to execute computer-executable instructions or programming codes to thereby perform an operation. Namely, the instructions or programming codes may be configured to cause the processor to perform an operation.

Reference throughout this specification to “one embodiment,” “embodiment,” “non-limiting exemplary embodiment,” “example embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In the present disclosure, specific tasks may be performed using Artificial Intelligence and/or Machine Leaning (AI/ML) models. An AI/ML model is a model generated using one or more AI technologies, one or more ML algorithm or both, and generates output data based on input data. This output data is used to perform tasks. Tasks performed using AI/ML models include those generally referred to as intellectual tasks, such as classification, prediction, natural language processing, etc.

Although AI and ML are explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transductive learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

As described above, anomaly diagnostic is an important aspect of a telecommunications network for timely identifying and mitigating network anomalies, thereby minimizing the impact of the network anomalies on the telecommunications network, enhancing network reliability, and ensuring a good user experience. Nevertheless, as described below, anomaly diagnostic in the related art is suboptimal and contains several shortcomings.

In the related art, network anomaly diagnostics are mainly centered on a cell-level approach, where performance anomalies and technical issues are isolated within specific network cells. While effective in technical terms, the approach in the related art often leaves a gap between how users perceive network anomalies and how network operators identify and address network issues. For instance, from the user’s perspective, complaints about network anomalies are typically made in terms of a location where the network anomalies occur (e.g., a railway line, a building name, etc.), rather than the underlying network information (e.g., cell identifier, etc.) that the network operators use for troubleshooting the network anomalies.

Accordingly, when a user reports a complaint about network anomalies to customer service, the lack of direct correlation between user-reported locations and network cell information may cause delays in communicating with technical teams, eventually leading to additional time spent on investigating the network components involved, as the network operators need to bridge the gap between the user’s complaint and technical diagnosis. This prolonged process between customer service representatives and technical teams delays both the diagnosis and the resolution of the network anomalies. Consequently, users may experience extended service disruptions and unsatisfactory responses, and the network operators may risk inefficient troubleshooting efforts and reduced customer satisfaction.

Example embodiments of the present disclosure, as described in the following, provide devices, systems, methods, and the like, that effectively and efficiently provide location-based network anomaly diagnostic, and ultimately address the shortcomings of the related art systems and methods.

Specifically, example embodiments of the present disclosure provide systems, devices, methods, operations, and the like, that implement an Anomaly Detection Component to determine network anomaly for a plurality of sections of a location (e.g., a plurality of railway sections, a plurality of building sections, etc.) and a Root Cause Analysis (RCA) Component to determine root cause or probable cause of the network anomaly detected at each section and then generate a report(s) that contains a summary of the network anomaly. The report(s) may be provided to the stakeholders or associated users thereafter.

Accordingly, example embodiments enable automated network anomaly diagnostic and reporting according to sections of a location, thereby bringing several technical advantages. Particularly, example embodiments may enable automated network anomaly detection and root cause analysis, thereby reducing mean time to resolution (MTTR), predicting and mitigating future network disruptions, enabling instant notification of network anomaly and prioritization of critical network issues, pinpointing specific problematic area(s) and reducing troubleshooting time, eliminating unnecessary checks and communication between different users and stakeholders, ensuring maximum user satisfaction and safety, and providing uninterrupted connectivity and improving user experiences.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of the example embodiments of the present disclosure are provided in the following.

### Example System Architecture

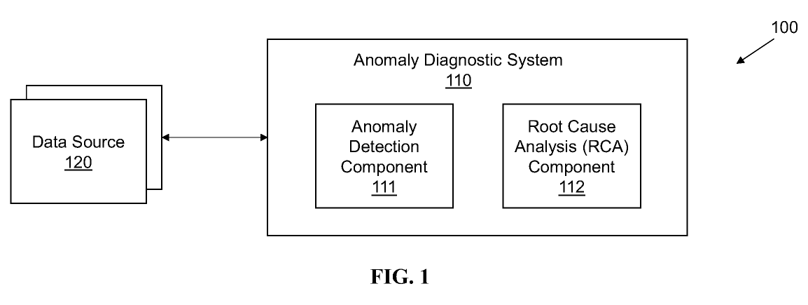

FIG. 1 illustrates a diagram of an example system configuration 100, according to one or more example embodiments. As shown in FIG. 1, the system configuration 100 may include an Anomaly Diagnostic System 110 and a plurality of Data Sources 120. The Anomaly Diagnostic System 110 may include an Anomaly Detection Component 111 and a Root Cause Analysis (RCA) Component 112.

It is contemplated that the system configuration 100 in FIG. 1 is merely an example and the configuration of the system and components therein may vary according to the requirements or implementations. For instance, in some example embodiments, multiple Anomaly Detection Components may be implemented, multiple RCA Components may be implemented, and the like, without departing from the scope of the present disclosure.

Furthermore, one or more of the components in system configuration 100, such as the Anomaly Detection Component 111 and the RCA Component 112, may be implemented in software form, hardware form, or a combination thereof. For instance, these components may be implemented as a virtualized or containerized network function, and may be deployed on a device or hardware component. The Anomaly Detection Component 111 and RCA Component 112 may be implemented in the same device or different devices. In this regard, descriptions such as “Anomaly Detection Component may perform an operation,” “RCA Component may be configured to perform an operation,” “a device may be configured to implement the Anomaly Detection Component to perform an operation,” and the like, may be interpreted as “a device (or a hardware component) may execute computer-readable instructions or programming codes associated with the Anomaly Detection Component/RCA Component to perform an operation associated therewith”.

Generally, the Anomaly Diagnostic System 110 may be configured to receive data from the Data Sources 120 and perform network anomaly diagnostics on the received data. Specifically, the Anomaly Detection Component 111 may communicate with the Data Sources 120 to receive data associated with a telecommunications network (e.g., cell coverage data, connectivity or internet session data, etc.), data associated with geospatial or a location (e.g., railway geospatial data, location section data, etc.), or a combination thereof. Accordingly, the Anomaly Detection Component 111 may determine, based on the received data, a plurality of anomaly detection results, each of which indicates whether a network anomaly has occurred in a respective section of a location. Subsequently, the Anomaly Detection Component 111 may provide, to the RCA Component 112, data associated with anomaly detection result(s) that indicates that a network anomaly has occurred. Accordingly, the RCA Component 112 may perform causal analysis on the received data to identify a potential root cause associated with the network anomaly, and then output (based on a result of the causal analysis) a report that includes a summary of the network anomaly. According to example embodiments, the RCA Component 112 may automatically provide the report to the associated users and stakeholders via, for example, an email, a short message service (SMS), and the like.

By way of an example, the Anomaly Detection Component 111 may receive data associated with cell coverage of a plurality of sections of a railway line and determine (based on the received data) a plurality of anomaly detection results, each of the anomaly detection results indicates whether a network anomaly has occurred in a respective one of the plurality of sections along the railway line. Subsequently, the Anomaly Detection Component 111 may provide, to the RCA Component 112, data associated with at least one of the anomaly detection results that indicates that a network anomaly has occurred (e.g., data of which railway section(s) has the network anomaly detected, etc.). The RCA Component 112 may receive, from the Anomaly Detection Component 111, the data associated with the at least one of the anomaly detection results that indicate that the network anomaly has occurred, perform a causal analysis on the received data to identify a potential root cause associated with the network anomaly, and output a report that includes a summary of the network anomaly. In this way, the Anomaly Detection Component 111 may detect a network anomaly for each section of the railway line, and the RCA Component 112 may further analyze the detected network anomaly by section of the railway line and provide a report associated therewith.

In view of the above, example embodiments of the present disclosure provide a system, a device, a component, and the like, that enable location-based network anomaly diagnostic. Specifically, example embodiments implement an Anomaly Detection Component (or a device that implements the Anomaly Detection Component) to receive data from various types of Data Sources and then determine network anomaly for a plurality of sections of a location (e.g., a plurality of railway sections, a plurality of building sections, etc.). Further, example embodiments also implement an RCA Component (or a device that implements the RCA Component) to determine the root cause or probable cause of the network anomaly detected at each section and then generate a report(s) that contains a summary of the network anomaly. The report(s) may be provided to the stakeholders or associated users.

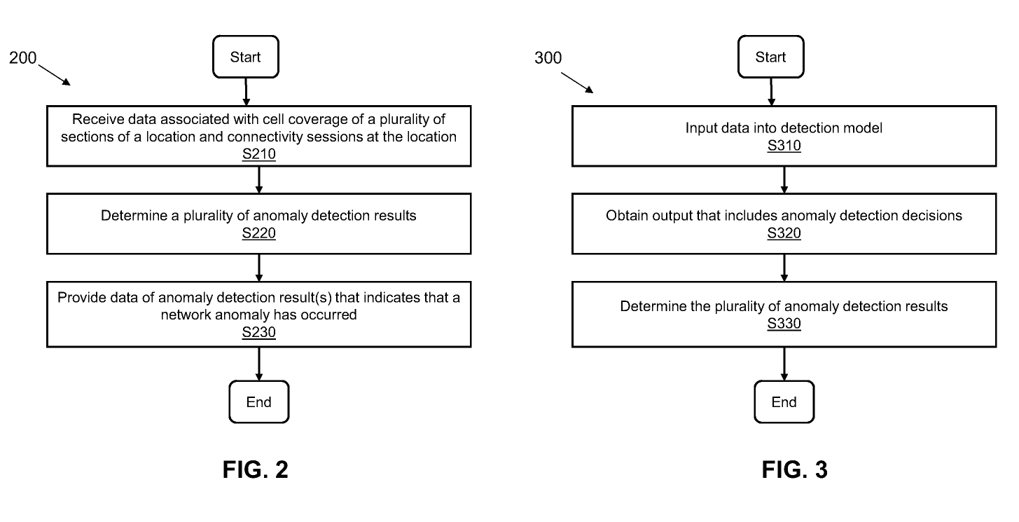

Ultimately, example embodiments of the present disclosure may provide an effective and efficient location-based network anomaly diagnostic. It is contemplated that features, advantages, and significances of example embodiments described hereinabove with reference to FIG. 1 are merely a portion of the present disclosure, and are not intended to be exhaustive or to limit the scope of the present disclosure. Further descriptions of example methods and operations associated with the components of system configuration 100 (e.g., Anomaly Detection Component 111, RCA Component 1112, etc.), as well as example use cases associated therewith, are provided below with reference to FIG. 2 to FIG. 7.

### Example Methods and Operations

As described above, the components in FIG. 1 (e.g., Anomaly Detection Component 111, RCA Component 112, etc.) may be configured to interoperate with each other and perform one or more methods and operations to provide location-based telecommunications network anomaly diagnostics. In the following, descriptions of several example methods and the associated operations are provided.

One or more operations (and the data involved therein) may be similar to those described above with reference to FIG. 1, thus it may be understood that the above-described operations and data may be similarly applied to the operations described hereinbelow (unless described otherwise) and redundant descriptions associated therewith may be omitted for conciseness.

For descriptive purposes, the methods and operations may be mainly described as being performed by one or more specific components, although it can be understood that, in actual implementations, another related component(s) may perform similar/related operations, without departing from the scope of the present disclosure. For instance, an operation of the Anomaly Detection Component (or a device that implements the Anomaly Detection Component) receiving data from a Data Source may indicate or suggest an operation of the Data Source providing the data to the Anomaly Detection Component (or the device that implements the Anomaly Detection Component), and the like.

According to example embodiments, one or more components of system configuration 100 in FIG. 1 may be implemented in one or more devices or hardware components, and one or more methods and operations described hereinbelow may be performed by the one or more devices/hardware components. For instance, the Anomaly Diagnostic System 110 (as well as the Anomaly Detection Component 111 and RCA Component 112 associated therewith) may be implemented in one or more devices that include a processor and a memory storage (or any other suitable storage mediums), wherein the memory storage may include computer-executable instructions or programming codes which, when being executed by the processor, cause the processor to perform one or more operations associated therewith.

FIG. 2 illustrates a diagram of an example method 200 for processing data to determine network anomaly for a plurality of sections of a location, according to one or more example embodiments. One or more operations of method 200 may be implemented by a device that implements an Anomaly Diagnostic System (or at least the Anomaly Detection Component associated therewith). Specifically, the device may be configured to implement the Anomaly Detection Component to perform (or the Anomaly Detection Component may be configured to perform) one or more operations of method 200.

Referring to FIG. 2, at operation S210, the Anomaly Detection Component may be configured to receive data associated with cell coverage of a plurality of sections of a location and connectivity sessions at the location. According to example embodiments, the location may include a railway line and the plurality of sections may include a plurality of sections of the railway line. Additionally or alternatively, the location may include a highway line, a bus line, a landmark, a building, and the like, each of which may be segmented into a plurality of sections.

According to example embodiments, the Anomaly Detection Component may be configured to receive the data from a plurality of Data Sources. For instance, the Anomaly Detection Component may receive the data from an internet provider (or a device associated therewith) that provides subscriber internet session data, a railway operator (or a device associated therewith) that provides railway geospatial data, a network management system that provides cell coverage data and/or E-UTRAN Cell Global Identifier (ECGI) data, and the like. In some example implementations, the Anomaly Detection Component may be configured to receive, from a data processing system (or a device associated therewith), a combination of cell coverage data and railway geospatial data, such as cell coverage data associated with a plurality of sections of a railway line, and the like.

At operation S220, the Anomaly Detection Component may be configured to determine, based on the received data, a plurality of anomaly detection results. In this regard, each of the anomaly detection results indicates whether a network anomaly has occurred in a respective one of the plurality of sections. For instance, the Anomaly Detection Component may determine whether a network anomaly has occurred in each of the plurality of sections of a railway line.

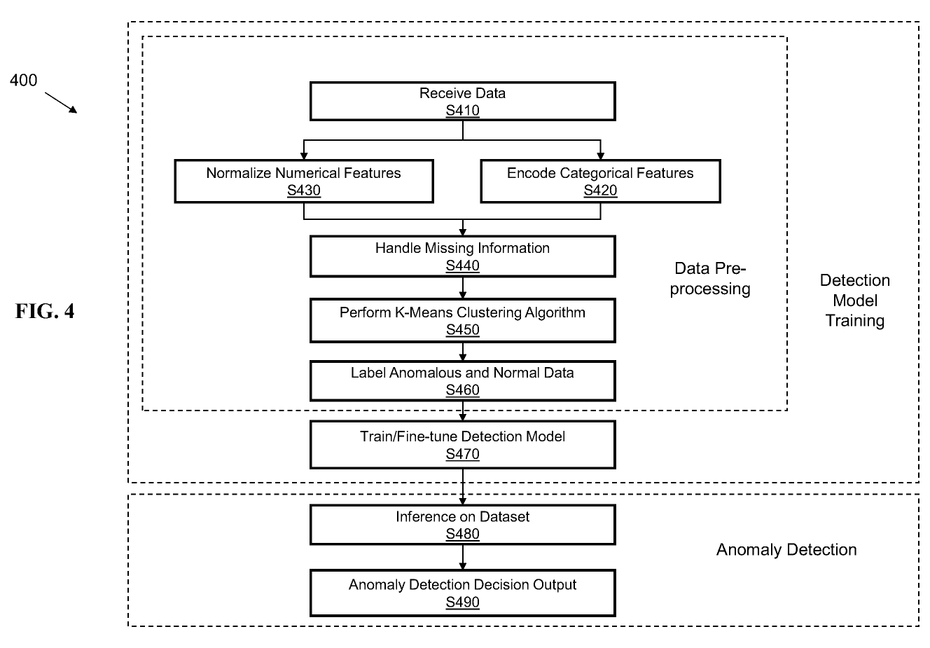

According to example embodiments, the Anomaly Detection Component may be configured to utilize one or more AI/ML models or features to determine the plurality of anomaly detection results. Descriptions of example operations associated therewith are provided below with reference to FIG. 3 and FIG. 4.

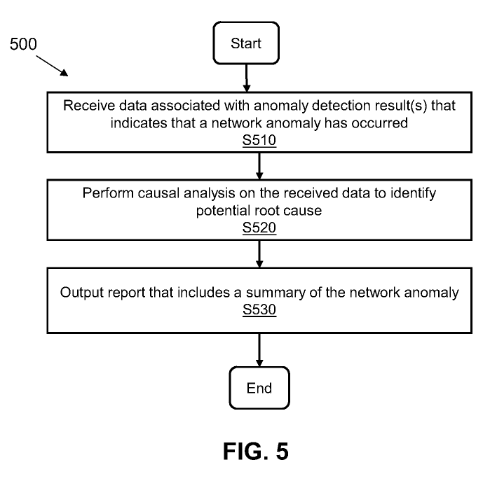

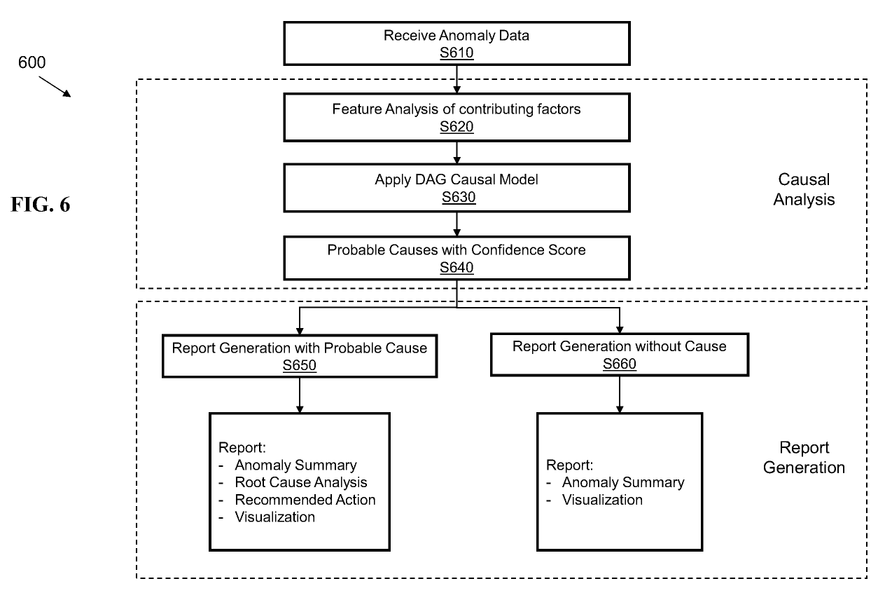

At operation S230, the Anomaly Detection Component may be configured to provide, to an RCA Component, data associated with at least one of the anomaly detection results that indicates that a network anomaly has occurred. Specifically, the Anomaly Detection Component may determine which of the plurality of anomaly detection results (determined at operation S220) indicates that a network anomaly has occurred, and then provide the associated data (e.g., railway section(s) at which the network anomaly is detected, type of network anomaly, cell coverage data and connectivity session data of the associated network section(s), etc.) to the RCA Component for further processing. Descriptions of example operations associated with the RCA Component are provided below with reference to FIG. 5 and FIG. 6.

FIG. 3 illustrates a diagram of an example method 300 for determining a plurality of anomaly detection results, according to one or more example embodiments. One or more operations of method 300 may be implemented by the device associated with FIG. 2. Specifically, the device may be configured to implement the Anomaly Detection Component to perform (or the Anomaly Detection Component may be configured to perform) one or more operations of method 300. In this regard, one or more operations of method 300 may be part of operation S220 of method 200.

Referring to FIG. 3, at operation S310, the Anomaly Detection Component may be configured to input data (e.g., data received at operation S210) into a detection model. In this regard, the detection model may refer to one or more AI/ML-based detection models or algorithms trained or fine-tuned for classifying, identifying, or flagging anomalous patterns within data. For instance, the detection model may include an unsupervised machine learning algorithm/model (e.g., a K-Means Clustering algorithm, an Isolation Forest, a Support Vector Machine (SVM), a Density-Based Clustering (DBSCAN), etc.) that learns the inherent structure of the data and identifies data points that deviate significantly from the norm, a neural network-based algorithm/model (e.g., an Autoencoder trained to reconstruct input data so that high reconstruction errors indicate anomalies, a Long Short-Term Memory (LSTM)-based model trained to learn temporal patterns and flags unusual sequences, etc.), and any other suitable types of AI/ML model or algorithm.

Additionally or alternatively, the detection model may include a hybrid model/algorithm that combines various models/algorithms. For instance, at the initial stage, a K-Means Clustering algorithm may be utilized to segment or group the data into clusters with similar characteristics, and then for each cluster, an Autoencoder may be utilized to learn the nuance of “normal” and “abnormal” patterns within that cluster. Accordingly, the detection model may effectively identify data (e.g., data that are poorly represented or exhibit high deviation from the “normal” behavior, data that are highly represented or exhibit low or no deviation from the “abnormal” behavior, etc.) that represent network anomaly.

According to example embodiments, the Anomaly Detection Component may be configured to pre-process the received data and train the detection model based on the pre-processed data. The Anomaly Detection Component may utilize the trained detection model to detect a network anomaly within the received data and/or data received in the subsequent iteration. Example operations of data pre-processing are described below with reference to the example use case in FIG. 4.

Referring still to FIG. 3, at operation S320, the Anomaly Detection Component may be configured to obtain an output from the detection model. In this regard, the output may include a plurality of anomaly detection decisions, each of which may be associated with one of the plurality of sections of the location. According to example embodiments, each of the anomaly detection decisions may include an anomaly score such as a numeric value that indicates the degree to which data deviates from “normal” behavior, a numeric value that indicates the similarity of data with “abnormal” behavior, and the like. Namely, at operation S320, each of the plurality of sections of the location may have an anomaly detection decision assigned thereto.

At operation S330, the Anomaly Detection Component may be configured to determine, based on the output obtained from the detection model, a plurality of anomaly detection results (similar to the anomaly detection results determined at operation S220). According to example embodiments in which the output includes a plurality of anomaly detection decisions (e.g., a plurality of anomaly scores, etc.), the Anomaly Detection Component may determine the plurality of anomaly detection results based on the plurality of anomaly detection decisions (e.g., applying a threshold to the plurality of anomaly scores, etc.).

FIG. 4 illustrates a diagram of an example use case 400 in which one or more operations in methods 200 and 300 may be implemented, according to one or more example embodiments. One or more operations of example use case 400 may be implemented by the Anomaly Detection Component (or a device that implements the Anomaly Detection Component). Specifically, the Anomaly Detection Component may be configured to perform (or the device may implement the Anomaly Detection Component to perform) one or more operations of method 200 and/or method 300 to implement example use case 400.

As illustrated in FIG. 4, example use case 400 may be segmented into several stages, such as the data pre-processing stage, the detection model training stage, and the anomaly detection stage. The data pre-processing stage may be part of the detection model training stage. It is contemplated that the example use case 400 is merely an example, and the scope of the present disclosure should not be limited thereto. For instance, in some example implementations, operations associated with the data pre-processing stage may be performed by other components, the detection model training stage may be optional and the input data may be utilized directly at the anomaly detection stage, and the like, without departing from the scope of the present disclosure.

Referring to FIG. 4, the Anomaly Detection Component may be configured to perform operations S410 to S460 to receive and preprocess data, perform operation S470 to train or fine-tune a detection model, and perform operation S480 to S490 to utilize the trained detection model to perform anomaly detection on the received data.

At operation S410, the Anomaly Detection Component may be configured to receive data from various data sources. This operation may be similar to operation S210 of method 200, thus redundant descriptions associated therewith may be omitted below for conciseness.

At operation S420, the Anomaly Detection Component may be configured to encode categorical features in the received data (e.g., text labels, nominal categories, etc.) to thereby obtain associated numerical representations therefrom. For instance, the Anomaly Detection Component may assign numerical values to different categorical features, map different categorical features to a number of columns using a hash function, replace different categorical features with associated numerical values, and the like. This operation encodes the categorical features into associated numerical representations, thereby maintaining the integrity of the information contained in the categorical features and ensuring that the categorical features are presented in a format that allows an algorithm (e.g., K-Means Clustering Algorithm, etc.) to learn meaningful patterns.

At operation S430, the Anomaly Detection Component may be configured to normalize numerical features in the received data (and numerical features obtained from operation S420, if any). For instance, the Anomaly Detection Component may rescale the numerical features (e.g., via min-max normalization, etc.) to a predetermined numerical range (e.g., [0, 1], [-1, 1], etc.), standardize the numerical features (e.g., via Z-score normalization, etc.), and the like. This operation normalizes and standardizes the numerical features in the data, thereby enabling the downstream operation (e.g., operation S450) to avoid bias toward features with larger scales.

Operations S420 and S430 may be performed in any suitable sequential manner. For instance, operations S420 and S430 may be performed simultaneously, operation S420 may be performed prior to operation S430, or operation S420 may be performed after operation S430.

At operation S440, the Anomaly Detection Component may be configured to handle missing information in the received data. For instance, the Anomaly Detection Component may replace a missing value with an estimated value (e.g., mean value, median value, etc.), perform interpolation to estimate a missing feature based on neighboring values, remove or ignore the missing information if it is not critical, and the like. This operation handles (e.g., supplements, removes, etc.) missing information in the received data, thereby ensuring data completeness, maintaining data integrity, and improving the quality of data for training/fine-tuning the detection model.

At operation S450, the Anomaly Detection Component may be configured to perform a K-Means Clustering Algorithm to group similar data (e.g., data with similar patterns or behaviors) into clusters. For instance, the Anomaly Detection Component may first determine an appropriate number of clusters and then perform clustering operations based thereon (e.g., select initial cluster centroids, calculate distances from each data point to all centroids and assign data to the nearest centroid, recalculate each centroid as the mean of all data points within each cluster, repeat the assignment and recalculating steps until the centroids converge or a maximum number of iterations is reached, etc.).

At operation S460, the Anomaly Detection Component may be configured to label the received data as anomalous and normal data based on the associated cluster. For instance, the Anomaly Detection Component may use the distance of each data point to the centroid of the associated cluster to label the associated data as normal data or anomalous (e.g., a data point that has a short distance to the centroid of the cluster of “normal behavior” may be labeled as “normal data”, etc.). In this regard, the specific threshold (e.g., threshold distance to the centroid, etc.) for labeling data as anomalous or normal may be defined by the network operator.

Upon performing operation S460, the date pre-processing stage may be completed. Subsequently, at operation S470, the Anomaly Detection Component may be configured to train or fine-tune a detection model for detecting a network anomaly. In this regard, “training a detection model” may refer to the operation of building a model from scratch by learning parameters from the provided training data, as well as the process of fine-tuning the detection model (thus, the terms “training a detection model” may include features of “fine-tuning a detection model”, unless being specified otherwise). On the other hand, “fine-tuning a detection model” may refer to the operation of training or refining a pre-trained detection model by adjusting the associated parameters based on new training data to improve performance.

According to example embodiments, the Anomaly Detection Component may train/fine-tune the detection model by: selecting a model architecture (e.g., unsupervised machine learning model, a neural network-based model, etc.) based on the nature of training data (e.g., data pre-processed via operations S410 to S460, etc.), anomaly detection objectives, preference of the network operator, and the like; inputting the training data into the selected model; optimizing the model with optimization algorithms (e.g., Adam, Stochastic Gradient Descent (SGD), etc.); validating the performance of the model; and iteratively perform the training, optimization, and validation operations over a predefined epochs.

In view of the above, operations S410 to S460 may be performed to pre-process the data to prepare appropriate training data, and operation S470 may be performed to train or fine-tune a detection model based on the training data. Upon performing operation S470, the detection model training stage may be completed and the detection model may be utilized in the anomaly detection stage. For instance, the Anomaly Detection Component may store the trained/fine-tuned detection model in a storage medium and then retrieve the detection model therefrom when required. According to example embodiments, operations S410 to S470 may be performed by a component or a device dedicated to the detection model training, and the Anomaly Detection Component may obtain the detection model from the component/device (or a storage medium that stores the trained/fine-tuned detection model) when required.

Referring still to FIG. 4, at operation S480, the Anomaly Detection Component may be configured to utilize the detection model (e.g., trained/fine-tuned at operation S470) to perform inference on a dataset. In this regard, this dataset may be part of the data received earlier (e.g., received at operation S410, etc.) or may refer to the data received after the training/fine-tuning of the detection model (e.g., data received in the next iteration, etc.). In this regard, at operation S480, the Anomaly Detection Component may input the dataset to the detection model, such that the detection model may process the dataset and infer network anomaly therein. This step may be similar to operation S310 of method 300.

At operation S490, the Anomaly Detection Component may be configured to obtain an output from the detection model. The output may include a plurality of anomaly detection decisions. This operation may be similar to operation S320 of method 300, thus redundant descriptions associated therewith may be omitted below for conciseness.

Next, methods, operations, and use cases associated with the RCA component are described with reference to FIG. 5 and FIG. 6. Referring first to FIG. 5, which illustrates a diagram of an example method 500 for performing causal analysis on data and output a report thereof, according to one or more example embodiments. One or more operations of method 500 may be implemented by an RCA component (or a device that implements the RCA Component). In some example embodiments, the RCA Component may be configured to perform (or the device may implement the RCA Component to perform) one or more operations of method 500, subsequent to one or more operations of method 200.

Referring to FIG. 5, at operation S510, the RCA Component may be configured to receive, from the Anomaly Detection Component, the data associated with the at least one of the anomaly detection results that indicates that a network anomaly has occurred. Operation S510 may be performed subsequent to operation S230 of method 200. The received data may include, for example, the timestamp of the network anomaly, the type of detected network anomaly, the section of location where the network anomaly is detected, and any other contextual information (e.g., network performance metrics, etc.) that may be utilized by the RCA component in identifying the cause of the network anomaly.

At operation S520, the RCA Component may be configured to perform a causal analysis on the received data to identify a potential root cause associated with the network anomaly. Several example operations associated therewith are described below with reference to the example use case in FIG. 6.

At operation S530, the RCA Component may be configured to output, based on a result of the causal analysis, a report that includes a summary of the network anomaly. In this regard, the report may include a report with a probable cause of the network anomaly (e.g., with supporting reasons, confidence scores, etc.) and/or a report without any cause of the network anomaly (e.g., no definitive cause was identified, etc.). In some example embodiments, the report may further include information of the root cause analysis, a recommended action to address the network anomaly, and/or one or more visual representations (e.g., charts, timelines, and the like, that illustrate how contributing factors are linked or how the network anomaly progressed over time, etc.).

FIG. 6 illustrates a diagram of an example use case 600 in which one or more operations in method 500 may be implemented, according to one or more example embodiments. One or more operations in example use case 600 may be implemented by the RCA Component (or a device that implements the RCA Component). Specifically, the RCA Component may be configured to perform (or the device may implement the RCA Component to perform) one or more operations of method 500 to implement example use case 600.

As illustrated in FIG. 6, example use case 600 may be segmented into several stages, such as the data reception stage, the causal analysis stage, and the report generation stage. It is contemplated that the example use case 600 is merely an example, and the scope of the present disclosure should not be limited thereto.

Referring to FIG. 6, at operation S610, the RCA Component may be configured to receive data associated with one or more detected network anomalies. This operation may be similar to operation S510 of method 500, thus redundant descriptions associated therewith may be omitted below for conciseness.

Upon receiving the data, the RCA Component may be configured to perform operations S620 to S640 to perform a causal analysis on the received data. Specifically, at operation S620, the RCA Component may be configured to analyze the received data to identify one or more contributing factors associated with the network anomaly.

In this regard, a “contributing factor” may refer to a parameter, variable, metric, or signal that might influence or contribute to the occurrence of a network anomaly. For instance, a contributing factor may include a performance metric (e.g., computing power utilization, network latency, packet loss, throughput, error rate, etc.) of the telecommunications network, a change in a network configuration (e.g., alternation in a security setting, an unexpected firmware/software change, etc.), an environmental condition (e.g., unusual temperature, electromagnetic interference, physical damage of a network component, etc.), and the like. According to example embodiments, the RCA Component may perform feature analysis on one or more contributing factors to identify which of the contributing factor(s) are the most related or associated with the network anomaly. For instance, the RCA Component may perform correlation analysis, mutual information, and/or principal analysis (PCA) to determine the relationship among multiple contributing factors and select the appropriate contributing factor(s) based thereon. (e.g., a high correlation between a sudden increment in CPU usage and increased network latency may suggest that CPU load is a contributing factor, etc.).

At operation S630, the RCA Component may be configured to apply a Directed Acyclic Graph (DAG) causal model to the identified one or more contributing factors to obtain a list of probable causes. In this regard, a “DAG causal model” may refer to a graphical model that contains a plurality of nodes, each of the nodes represents a contributing factor and each of the arrows that connects the nodes indicates the direction of causation, with the structure ensuring that the DAG does not contain any cycles (i.e., a contributing factor cannot directly or indirectly cause itself). Namely, the DAG causal model visually depicts the “cause-and-effect” relationship between different contributing factors, allowing the determination of potential causal pathways. Thus, the RCA Component may apply the DAG causal model (which may be constructed by the network operators, built by the RCA Component, etc.) to the one or more contributing factors (identified at operation S620) to obtain a list of probable causes. For instance, the RCA Component may perform causal analysis based on the DAG causal model (e.g., estimate the strength of causal relationships among the contributing factors, perform causal inference, etc.). The output of the causal analysis may include the list of probable causes, which may be a ranked list of contributing factors where the DAG causal model quantifies how likely each contributing factor is responsible for the network anomaly, effectively isolating the potential root cause(s) of the network anomaly from other contributing factors.

At operation S640, the RCA Component may be configured to assign a confidence score to each of the probable causes. The confidence score may reflect a likelihood or probability that the associated probable cause is the root cause of the network anomaly. According to example embodiments, each edge/arrow of the DAG causal model may be assigned a weight or a probability, and the RCA Component may implement one or more statistical operations (e.g.., regression analysis, Bayesian inference, etc.) to evaluate the strength of the causal relationships between the contributing factors associated with the probable causes and then calculate a confidence score for each of the probable causes based thereon.

Upon performing operation S640, the causal analysis stage may be completed. At this stage, the RCA Component may successfully identify one or more probable causes for the network anomaly, or may be unable to conclusively identify any probable cause for the network anomaly. In the former scenario, the example use case may proceed to operation S650, at which the RCA Component may be configured to generate a report that contains the probable cause(s), as well as a summary of the network anomaly, a root cause analysis, a recommended action for addressing the network anomaly (e.g., to address the probable cause(s), etc.), and visualization (e.g., chart, etc.) associated therewith. In the latter scenario, the RCA Component may be configured to generate a report without any probable cause. In this case, the report may still contain the summary of the network anomaly and a visualization associated therewith, and may include a statement that no definitive root cause was determined.

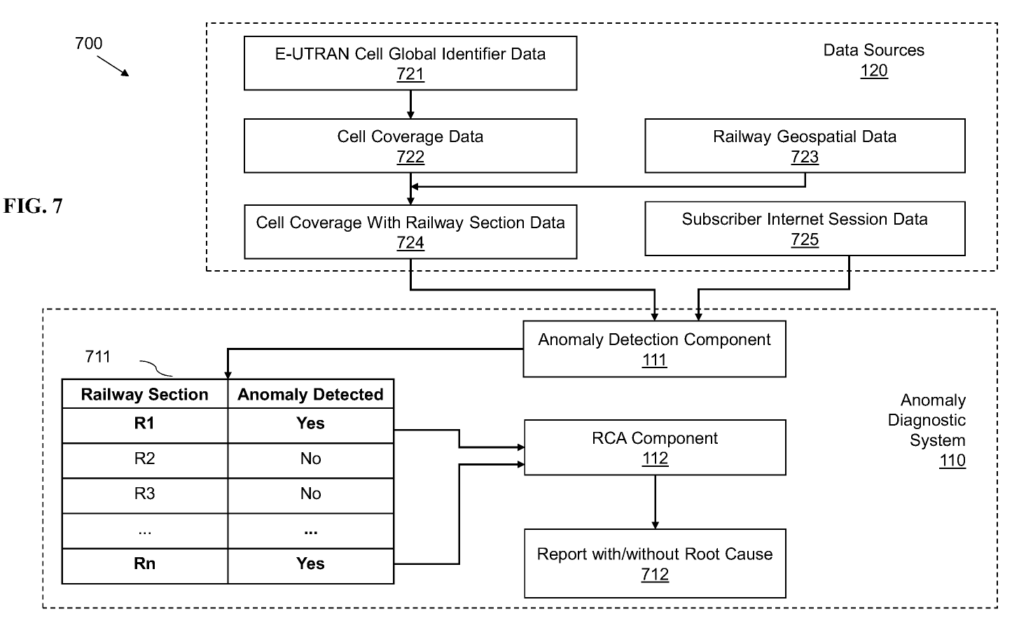

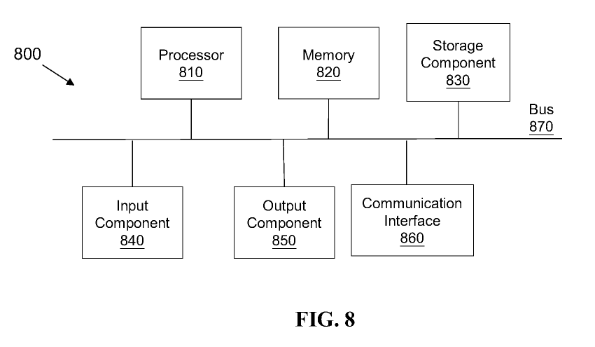

Next, an example use case, in which the methods, operations, and use cases associated with the Anomaly Detection Component and RCA Component may be implemented, is described with reference to FIG. 7.

Specifically, FIG. 7 illustrates a diagram of an example use case 700 for performing network anomaly diagnostic for a plurality of sections of a railway line, according to one or more example embodiments. The Anomaly Diagnostic System 110 (as well as the Anomaly Detection Component 111 and RCA Component 112 associated therewith) and the Data Source 120 in FIG. 1 may involve in this example use case, thus the reference numerals of these components remain the same as those presented in FIG. 1.

As illustrated in FIG. 7, in example use case 700, the Data Sources 120 may include a data source 721 that provides E-UTRAN Cell Global Identifier (ECGI) Data, a data source 722 that provides cell coverage data based on the ECGI data provided by the data source 721, a data source 723 that provides railway geospatial data, a data source 724 that provides cell coverage data of a plurality of railway sections, and a data source 725 that provides subscriber internet session data.

In this regard, the data source 721 may include a base station (e.g., eNodeB, gNodeB, etc.), a network management system (NMS) that manages the base station, and the like. The data source 722 may include a network planning tool, a data processing device, and the like, that obtain the ECGI data from the data source 721 and determine cell coverage data based thereon. The data source 723 may include a geographic information system (GIS), a railway management system, and the like, that manage geospatial data of a railway line (e.g., railway line distance, stations along the railway line, tracks of the railway line, coordinates along the railway line, etc.). The data source 724 may include a device, system, and the like, that collects data from the data sources 722 and 723, and then generates cell coverage data according to a plurality of sections of the railway line. The data source 725 may include a device, system, and the like, that provides internet session data of the subscribers, which may be utilized to determine a connectivity session of a user, whether the user is on the train that runs/drives along the railway line when the network anomaly is detected/reported, and the like. One or more of the data sources 721 to 725 may be managed by the network operator, a vendor, a service provider, and the like. By aggregating data from these data sources, the anomaly diagnostic system 110 may gather and collect a comprehensive view of cell coverage, network performance, and user experience, particularly along a railway line.

The data sources 724 and 725 may communicate with the Anomaly Detection Component 111 (or a device that implements the Anomaly Detection Component 111) and provide data thereto. Accordingly, the Anomaly Detection Component 111 may be configured to perform (or a device that implements the Anomaly Detection Component 111 may be configured to perform) one or more operations of method 200, method 300, and/or example use case 400, thereby determining a plurality of anomaly detection results each of which is associated with a respective section of the railway line. For instance, in the example use case 700, the plurality of anomaly detection results are combined and presented in Table 711, in which the anomaly detection result of each of railway sections R1 to Rn (where N is any suitable natural number) is included.

Accordingly, the Anomaly Detection Component 111 (or the associated device) may provide, to the RCA Component 112 (or a device that implements the RCA Component 112) data associated with one or more anomaly detection results that indicate that a network anomaly has occurred. In example use case 700, network anomaly is detected at railway sections R1 and Rn. Thus, the Anomaly Detection Component 111 (or the associated device) may provide data associated with the anomaly detection results of railway sections R1 and Rn to the RCA Component 112 (or the associated device) for further processing.

Upon receiving the data from the Anomaly Detection Component 111 (or the associated device), the RCA Component 112 (or the associated device) may be configured to perform one or more operations of method 500 and/or example use case 600 to perform causal analysis on the network anomaly detected at railway sections R1 and Rn and output a consolidated report (or multiple reports each of which dedicated to a railway section) with or without the root cause (or probable cause) of the detected network anomaly. The report(s) may be stored in a storage medium and may be retrieved and utilized (e.g., by a customer service user, etc.) at a later time.

In view of the above, example embodiments of the present disclosure provide method and operations performable or implementable by one or more components, devices, systems, and the like, to provide location-based network anomaly diagnostic.

Specifically, one or more of the methods, operations, and use cases in FIG. 2 to FIG. 7 may be automatically implemented by an Anomaly Detection Component and an RCA Component to enable location-based network anomaly diagnostic. For instance, the Anomaly Detection Component (or a device that implements the Anomaly Detection Component) may detect a network anomaly of a plurality of sections of a location (e.g., a railway line) and identify section(s) at which the network anomaly is detected. The data of the identified section(s) may be provided to an RCA Component (or a device that implements the RCA Component) to perform causal analysis and generate a report associated therewith, such that the details about the network anomaly of the identified sections(s) would be readily readable when required (e.g., the report may be utilized by a customer service team when a network subscriber make a complaint about network issues to the customer service team, etc.).

To this end, methods and operations of example embodiments may be implemented to provide efficient and effective location-based network anomaly diagnostic, thereby achieving the technical advantages described hereinabove. It is contemplated that, the methods, operations, advantages, and significances described above with reference to FIG. 2 to FIG. 7 are merely examples and the scope of the present disclosure should not be limited thereto. Specifically, one or more operations in FIG. 2 to FIG. 7 may be performed differently, fewer or additional operations may be involved, additional advantages may be achieved, and the like, without departing from the scope of the present disclosure.

### Examples of Device

One or more components of the example embodiments (e.g., Anomaly Detection Component, RCA Component, etc.), as well as the operations associated therewith, may be implemented in one or more devices or hardware components. For instance, one or more components/operations of the Anomaly Detection Component and/or RCA Component may be implemented in one or more devices like a server(s), and the like.

In the following, descriptions of a device in which the example embodiments may be implemented are provided. It is contemplated that one or more features, operations, and methods described above may be performed by the device. For instance, the one or more operations or methods associated with the Anomaly Detection Component and/or RCA Component may be performed by at least one processor of the device upon executing machine-readable instructions or computer-readable instructions stored in a memory or a storage component of the device.

FIG. 8 illustrates an embodiment of a device 800. As shown in FIG. 8, the device 800 may include a processor 810, a memory 820, a storage component 830, an input component 840, an output component 850, a communication interface 860, and a bus 870.

The processor 810, as used herein, means any type of computational circuit that may comprise hardware elements and software elements. The processor 810 may be embodied as a multi-core processor, a single core processor, or a combination of one or more multi-core processors and/or one or more single core processors, a distributed processing system, or the like. The processor 810 may be a Central Processing Unit (CPU), a graphics processing unit (GPU), an accelerated processing unit (APU), an application-specific integrated circuit (ASIC), or another type of processing component.

Memory 820 includes a non-transitory computer readable medium. Memory 820 includes a random-access memory (RAM), a read only memory (ROM), and/or another type of dynamic or static storage device (e.g., a flash memory, a magnetic memory, and/or an optical memory) that stores information and/or instructions for use by processor 810. The memory 820 comprises machine-readable instructions which are executable by the processor 810. These machine-readable instructions when executed by the processor 810 cause the processor 810 to perform one or more method steps of an embodiment described above.

Storage component 830 stores information and/or software related to the operation and use of the device 800. For example, storage component 830 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 840 is configured to receive information, such as user input. For example, the input component 840 may include, but not be limited to, a touch screen display, a keyboard, a keypad, a mouse, a button, a switch, and/or a microphone. Additionally, or alternatively, the input component 840 may include a sensor for sensing information (e.g., a global positioning system (GPS), an accelerometer, a gyroscope, and/or an actuator).

Output component 850 is configured to provide output information from the device 800. For example, the output component 850 may be, but not limited to, a display, a speaker, instructions to an external device, and/or one or more light-emitting diodes (LEDs).

Communication interface 860 is an interface that provides a communication connection to other devices, such as external devices and internal devices. The connection by the communication interface 860 can be a wired connection, a wireless connection, or a combination of wired and wireless connections, and can be a direct connection or an indirect connection via a communication network that exists between the device 800 and other devices. In other words, the standard of the communication interface 860 is not limited.

The bus 870 acts as an interconnect between the processor 810, the memory 820, the storage component 830, the input component 840, the output component 850, and the communication interface 860 of the device 800. The bus 870 may include a wired interconnection or a wireless interconnection.

The number and arrangement of components shown in FIG. 8 are provided as an example. In practice, device 800 may include additional components, fewer components, different components, or differently arranged components than those shown in FIG. 8. Additionally, or alternatively, a set of components (e.g., one or more components) of device 800 may perform one or more functions described as being performed by another set of components of device 800. Further, one or more method steps described in any of the embodiments may be performed utilizing a plurality of devices 800 in communication with one another.

### Example Implementation Environment

Example embodiments of the present disclosure may be implemented in any suitable type of environment. In the following, an example environment (in which the example embodiments may be implemented) is described.

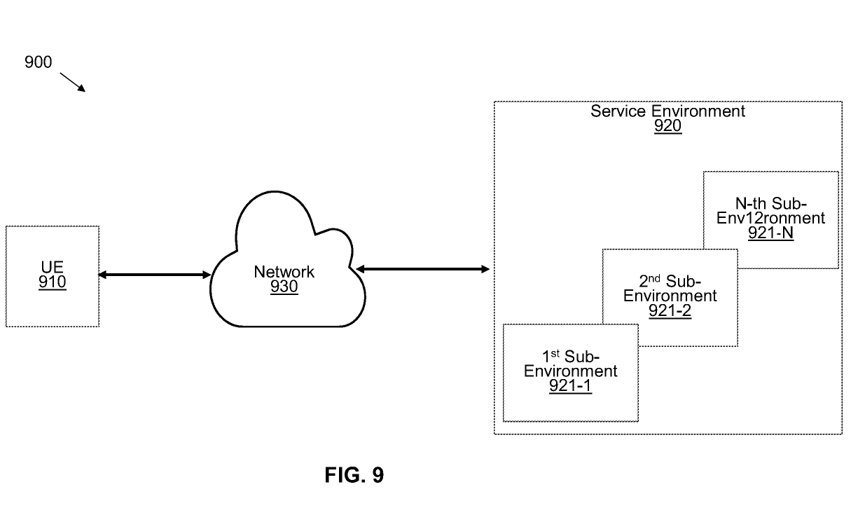

FIG. 9 illustrates a diagram of an example environment 900 in which systems and/or method, described herein, may be implemented. The implementation environment 900 includes a UE (User equipment) 910, a service environment 920, and a network 930. The service environment 920 includes one or more sub-environments 921. To illustrate this, FIG. 9 shows, for convenience, examples of a 1st sub-environment 921-1, a2nd sub-environment 921-2, and an N-th sub-environment 921-N (where N is any natural number).

The UE 910 is connected to the network 930, and the network 930 is connected to the service environment 920. The connections may be wired, wireless, or a combination of both wired and wireless. The UE 910 and the service environment 920 are connected via the network 930.

The UE 910 is a device that communicates with the service environment 920. The UE 910 receives information from the service environment 920 and/or sends information to the service environment 920. Also, the UE 910 may generate and/or store information to be transmitted, as necessary. Also, the UE 910 may store and/or process information that is received, as necessary.

The example FIG. 9 refers to the “UE”. However, it should be understood by those skilled in the art that general terms such as “user device,” “terminal,” “terminal device,” “communication device,” and “communication terminal” can be used interchangeably with the term “UE.”

For example, the UE 910 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 920 is an environment that communicates with the UE 910 to provide one or more services. The service environment 920 receives information from the UE 910 and/or sends information to the UE 910. Also, the service environment 920 may generate and/or store information to be transmitted, as necessary. Also, the service environment 920 may store and/or process information that is received, as necessary. For example, the service environment 920 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 9 refers to the “service environment”. The term "service environment" is used to refer to the broader context within which services operate. For example, cloud environments, platforms, computing systems, network systems, and cloud systems generally represent the environments in which services are conducted, and these are included within the "service environment." However, the "service environment" is not limited to these examples. Additionally, the specific types of environments within the "service environment" are not restricted. For instance, cloud environments and cloud systems can be categorized as private cloud, public cloud, hybrid cloud, or multi-cloud, all of which are included within the "service environment."

The one or more services provided by the service environment 920 is not specifically limited and can be adjusted according to the embodiments. For example, the services may include a service that provides information to the UE 910, a service that stores information from the UE 910, or a service that performs processing based on information from the UE 910 and returns the results of the processing.

In an embodiment, the Service Environments 920 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as "Virtual" or "Virtualized" to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 920 includes one or more devices, such as servers and network devices, which provide services or perform processes. The placement of these devices within the service environment 920 can be determined as appropriate. Additionally, if the service environment 920 includes one or more sub-environments 921, the placement of devices can be determined based on predetermined policies for each sub-environment 921. For example, devices related to the first service may be placed in the 1st sub-environment 921-1, and devices related to the second service may be placed in the 2nd sub-environment 921-2. In another example, devices expected to have a higher load than a predetermined threshold may be placed in the 1st sub-environment 921-1, while devices expected to have a lower load than the predetermined threshold may be placed in the 2nd sub-environment 921-2. In this way, specific devices can be placed in specific sub-environments 921. Conversely, each sub-environment 921 can be specialized for a particular purpose.

In an embodiment, all processes executed in a single service may run within a single service environment, or in multiple service environments. Multiple processes executed in a single service could be provided by different service environments.

The network 930 is a network that exchanges information between the UE 910 and the service environment 920. The network 930 includes one or more wired and/or wireless networks.

For example, the network 930 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 930 can be a part of a network. For example, in a 5G network that includes a RAN, a transport network, and a core network, the network 930 can be at least one of the RAN, the transport network, or the core network. For example, the service environment 920 could be in the core network, in which case the network 930 could correspond to a network that is a combination of a RAN and a transport network and is part of the 5G network.

The number and arrangement of devices and networks shown in FIG. 9 are provided as an example. It should be understood that any changes that may be implemented by those skilled in the art, such as the addition or rearrangement of well-known devices or networks at the time of implementation, are included in this disclosure.

### Various Aspects of Embodiments

It is contemplated that features, advantages, and significances of example embodiments described hereinabove are merely examples of the present disclosure, and are not intended to be exhaustive or to limit the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device, a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the "C" programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:

Item [1]: A device comprising: an Anomaly Detection Component configured to: receive data associated with cell coverage of a plurality of sections of a location and connectivity sessions at the location; determine, based on the received data, a plurality of anomaly detection results, wherein each of the anomaly detection results indicates whether a network anomaly has occurred in a respective one of the plurality of sections; and provide, to a Root Cause Analysis (RCA) Component, data associated with at least one of the anomaly detection results that indicates that a network anomaly has occurred.

Item [2]: The device according to item [1], wherein the Anomaly Detection Component is configured to determine the plurality of anomaly detection results by: inputting the received data into a detection model; obtaining an output from the detection model, wherein the output includes a plurality of anomaly detection decisions, and wherein each of the anomaly detection decisions is associated with one of the sections of the location; and determining, based on the output, the plurality of anomaly detection results.

Item [3]: The device according to item [2], wherein the Anomaly Detection Component is further configured to pre-process the received data and train the detection model based on the pre-processed data.

Item [4]: The device according to item [3], wherein the Anomaly Detection Component is configured to pre-process the received data by: encoding categorical features in the received data to convert non-numerical features into numerical features; normalizing numerical features in the received data; handling missing information in the received data; performing a K-means clustering algorithm on the received data to group the received data into a plurality of clusters; and labeling the received data as anomalous data and normal data based on the associated cluster.

Item [5]: The device according to one or more of items [1]-[4], wherein the device further comprises the RCA component, and wherein the RCA component is configured to: receive, from the Anomaly Detection Component, the data associated with the at least one of the anomaly detection results that indicates that a network anomaly has occurred; perform a causal analysis on the received data to identify a potential root cause associated with the network anomaly; and output, based on a result of the causal analysis, a report that includes a summary of the network anomaly.

Item [6]: The device according to item [5], wherein the RCA component is configured to perform the causal analysis by: analyzing the received data to identify one or more contributing factors associated with the network anomaly; applying a Directed Acyclic Graph (DAG) causal model to the identified one or more contributing factors to obtain a list of probable causes; and assigning a confidence score to each of the probable causes.

Item [7]: The device according to one or more of items [5]-[6], wherein the report comprises at least one of: a report with a probable cause of the network anomaly and a report without any cause of the network anomaly.

Item [8]: The device according to one or more of items [1]-[7], wherein the location comprises a railway line, and wherein the plurality of sections comprises a plurality of sections of the railway line.

Item [9]: A method comprising: receiving data associated with cell coverage of a plurality of sections of a location and connectivity sessions at the location; determining, based on the received data, a plurality of anomaly detection results, wherein each of the anomaly detection results indicates whether a network anomaly has occurred in a respective one of the plurality of sections; and providing, to a Root Cause Analysis (RCA) Component, data associated with at least one of the anomaly detection results that indicates that a network anomaly has occurred.

Item [10]: The method according to item [9], wherein the determining the plurality of anomaly detection results comprises: inputting the received data into a detection model; obtaining an output from the detection model, wherein the output includes a plurality of anomaly detection decisions, and wherein each of the anomaly detection decisions is associated with one of the sections of the location; and determining, based on the output, the plurality of anomaly detection results.

Item [11]: The method according to item [10], further comprising pre-processing the received data and training the detection model based on the pre-processed data.

Item [12]: The method according to item [11], wherein the pre-processing the received data comprises: encoding categorical features in the received data to convert non-numerical features into numerical features; normalizing numerical features in the received data; handling missing information in the received data; performing a K-means clustering algorithm on the received data to group the received data into a plurality of clusters; and labeling the received data as anomalous data and normal data based on the associated cluster.

Item [13]: The method according to one or more of items [9]-[12], further comprising: receiving, from an Anomaly Detection Component, the data associated with the at least one of the anomaly detection results that indicates that a network anomaly has occurred performing a causal analysis on the received data to identify a potential root cause associated with the network anomaly; and outputting, based on a result of the causal analysis, a report that includes a summary of the network anomaly.

Item [14]: The method according to item [13], wherein the performing the causal analysis comprises: analyzing the received data to identify one or more contributing factors associated with the network anomaly; applying a Directed Acyclic Graph (DAG) causal model to the identified one or more contributing factors to obtain a list of probable causes; and assigning a confidence score to each of the probable causes.

Item [15]: The method according to one or more of items [13]-[14], wherein the report comprises at least one of: a report with a probable cause of the network anomaly and a report without any cause of the network anomaly.

Item [16]: The method according to one or more of items [9]-[15], wherein the location comprises a railway line, and wherein the plurality of sections comprises a plurality of sections of the railway line.

Item [17]: A non-transitory computer-readable recording medium having recorded thereon instructions executable by a device to cause the device to perform a method comprising: receiving data associated with cell coverage of a plurality of sections of a location and connectivity sessions at the location; determining, based on the received data, a plurality of anomaly detection results, wherein each of the anomaly detection results indicates whether a network anomaly has occurred in a respective one of the plurality of sections; and providing, to a Root Cause Analysis (RCA) Component, data associated with at least one of the anomaly detection results that indicates that a network anomaly has occurred.

Item [18]: The non-transitory computer-readable recording medium according to item [17], wherein the determining the plurality of anomaly detection results comprises: inputting the received data into a detection model; obtaining an output from the detection model, wherein the output includes a plurality of anomaly detection decisions, and wherein each of the anomaly detection decisions is associated with one of the sections of the location; and determining, based on the output, the plurality of anomaly detection results.

Item [19]: The non-transitory computer-readable recording medium according to item [18], wherein the method further comprises pre-processing the received data and training the detection model based on the pre-processed data.

Item [20]: The non-transitory computer-readable recording medium according to one or more of items [17]-[19], wherein the method further comprises: receiving, from an Anomaly Detection Component, the data associated with the at least one of the anomaly detection results that indicates that a network anomaly has occurred; performing a causal analysis on the received data to identify a potential root cause associated with the network anomaly; and outputting, based on a result of the causal analysis, a report that includes a summary of the network anomaly.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A device comprising:
an Anomaly Detection Component configured to:
receive data associated with cell coverage of a plurality of sections of a location and connectivity sessions at the location;
determine, based on the received data, a plurality of anomaly detection results, wherein each of the anomaly detection results indicates whether a network anomaly has occurred in a respective one of the plurality of sections; and
provide, to a Root Cause Analysis (RCA) Component, data associated with at least one of the anomaly detection results that indicates that a network anomaly has occurred.

2. The device according to claim 1, wherein the Anomaly Detection Component is configured to determine the plurality of anomaly detection results by:
inputting the received data into a detection model;
obtaining an output from the detection model, wherein the output includes a plurality of anomaly detection decisions, and wherein each of the anomaly detection decisions is associated with one of the sections of the location; and
determining, based on the output, the plurality of anomaly detection results.

3. The device according to claim 2, wherein the Anomaly Detection Component is further configured to pre-process the received data and train the detection model based on the pre-processed data.

4. The device according to claim 3, wherein the Anomaly Detection Component is configured to pre-process the received data by:
encoding categorical features in the received data to convert non-numerical features into numerical features;
normalizing numerical features in the received data;
handling missing information in the received data;
performing a K-means clustering algorithm on the received data to group the received data into a plurality of clusters; and
labeling the received data as anomalous data and normal data based on the associated cluster.

5. The device according to claim 1, wherein the device further comprises the RCA component, and wherein the RCA component is configured to:
receive, from the Anomaly Detection Component, the data associated with the at least one of the anomaly detection results that indicates that a network anomaly has occurred;
perform a causal analysis on the received data to identify a potential root cause associated with the network anomaly; and
output, based on a result of the causal analysis, a report that includes a summary of the network anomaly.

6. The device according to claim 5, wherein the RCA component is configured to perform the causal analysis by:
analyzing the received data to identify one or more contributing factors associated with the network anomaly;
applying a Directed Acyclic Graph (DAG) causal model to the identified one or more contributing factors to obtain a list of probable causes; and
assigning a confidence score to each of the probable causes.

7. The device according to claim 5, wherein the report comprises at least one of: a report with a probable cause of the network anomaly and a report without any cause of the network anomaly.

8. The device according to claim 1, wherein the location comprises a railway line, and wherein the plurality of sections comprises a plurality of sections of the railway line.

9. A method comprising:
receiving data associated with cell coverage of a plurality of sections of a location and connectivity sessions at the location;
determining, based on the received data, a plurality of anomaly detection results, wherein each of the anomaly detection results indicates whether a network anomaly has occurred in a respective one of the plurality of sections; and
providing, to a Root Cause Analysis (RCA) Component, data associated with at least one of the anomaly detection results that indicates that a network anomaly has occurred.

10. The method according to claim 9, wherein the determining the plurality of anomaly detection results comprises:
inputting the received data into a detection model;
obtaining an output from the detection model, wherein the output includes a plurality of anomaly detection decisions, and wherein each of the anomaly detection decisions is associated with one of the sections of the location; and
determining, based on the output, the plurality of anomaly detection results.

11. The method according to claim 10, further comprising pre-processing the received data and training the detection model based on the pre-processed data.

12. The method according to claim 11, wherein the pre-processing the received data comprises:
encoding categorical features in the received data to convert non-numerical features into numerical features;
normalizing numerical features in the received data;
handling missing information in the received data;
performing a K-means clustering algorithm on the received data to group the received data into a plurality of clusters; and
labeling the received data as anomalous data and normal data based on the associated cluster.

13. The method according to claim 9, further comprising:
receiving, from an Anomaly Detection Component, the data associated with the at least one of the anomaly detection results that indicates that a network anomaly has occurred;
performing a causal analysis on the received data to identify a potential root cause associated with the network anomaly; and
outputting, based on a result of the causal analysis, a report that includes a summary of the network anomaly.

14. The method according to claim 13, wherein the performing the causal analysis comprises:
analyzing the received data to identify one or more contributing factors associated with the network anomaly;
applying a Directed Acyclic Graph (DAG) causal model to the identified one or more contributing factors to obtain a list of probable causes; and
assigning a confidence score to each of the probable causes.

15. The method according to claim 13, wherein the report comprises at least one of: a report with a probable cause of the network anomaly and a report without any cause of the network anomaly.

16. The method according to claim 9, wherein the location comprises a railway line, and wherein the plurality of sections comprises a plurality of sections of the railway line.

17. A non-transitory computer-readable recording medium having recorded thereon instructions executable by a device to cause the device to perform a method comprising:
receiving data associated with cell coverage of a plurality of sections of a location and connectivity sessions at the location;
determining, based on the received data, a plurality of anomaly detection results, wherein each of the anomaly detection results indicates whether a network anomaly has occurred in a respective one of the plurality of sections; and
providing, to a Root Cause Analysis (RCA) Component, data associated with at least one of the anomaly detection results that indicates that a network anomaly has occurred.

18. The non-transitory computer-readable recording medium according to claim 17, wherein the determining the plurality of anomaly detection results comprises:
inputting the received data into a detection model;
obtaining an output from the detection model, wherein the output includes a plurality of anomaly detection decisions, and wherein each of the anomaly detection decisions is associated with one of the sections of the location; and
determining, based on the output, the plurality of anomaly detection results.

19. The non-transitory computer-readable recording medium according to claim 18, wherein the method further comprises pre-processing the received data and training the detection model based on the pre-processed data.

20. The non-transitory computer-readable recording medium according to claim 17, wherein the method further comprises:
receiving, from an Anomaly Detection Component, the data associated with the at least one of the anomaly detection results that indicates that a network anomaly has occurred;
performing a causal analysis on the received data to identify a potential root cause associated with the network anomaly; and
outputting, based on a result of the causal analysis, a report that includes a summary of the network anomaly.
